(19) United States
(12) Patent Application Publication
(10) Pub. No.: US 2026/0018119 A1
(43) Pub. Date: Jan. 15, 2026

(54) DISPLAY PANEL AND DISPLAY DEVICE

(71) Applicants: Chengdu BOE Optoelectronics Technology Co., Ltd., Chengdu, Sichuan (CN); BOE TECHNOLOGY GROUP CO., LTD., Beijing (CN)

(72) Inventors: Tiaomei ZHANG, Beijing (CN); Ziyang YU, Beijing (CN); Zhiliang JIANG, Beijing (CN); Pan ZHAO, Beijing (CN); Ming HU, Beijing (CN); Xu LIU, Beijing (CN)

(73) Assignees: Chengdu BOE Optoelectronics Technology Co., Ltd., Chengdu, Sichuan (CN); BOE TECHNOLOGY GROUP CO., LTD., Beijing (CN)

(21) Appl. No.: 18/995,855

(22) PCT Filed: Apr. 24, 2024
(86) PCT No.: PCT/CN2024/089453

§ 371 Date: Jan. 17, 2025

(30) Foreign Application Priority Data
May 29, 2023 (CN) 202310621389.0

(51) Int. Cl. G09G 3/3225

(52) U.S. Cl. CPC G09G 3/3225; G09G 3/3233; G09G 2300/0426; G09G 2300/0439; G09G 2300/0452

(57) ABSTRACT

Disclosed is a display panel. The display panel includes: a base substrate, a drive circuit, disposed on the base substrate and including a plurality of drive units, the drive units including n rows of drive terminals; a plurality of sub-pixel clusters, disposed on the base substrate, wherein each of the sub-pixel clusters includes n rows of sub-pixels of m colors, the n rows of sub-pixels form n sub-pixel groups, each of the sub-pixel groups includes sub-pixels of at least one color, the n sub-pixel groups correspond to the n rows of drive terminals respectively, and the sub-pixels in the sub-pixel groups are electrically connected to the corresponding drive terminals.

### CROSS REFERENCE TO RELATED APPLICATIONS

The application a U.S. national phase application based on PCT/CN2024/089453, filed on Apr. 24, 2024, which claims priority to Chinese Patent Application No. 202310621389.0, filed on 29 May 2023, entitled “DISPLAY PANEL AND DISPLAY DEVICE,” both of which are incorporated by reference herein.

### TECHNICAL FIELD

The disclosure relates to the field of display technologies, and in particular, relates to a display panel and a display device.

### BACKGROUND

Display panels are devices capable of implementing the display function.

A display panel typically includes a drive circuit and a plurality of rows of light-emitting units. The drive circuit includes a plurality of drive units. Each of the drive units is configured to drive two rows of light-emitting units, such that the drive circuit is structurally simplified while the light-emitting units are driven to emit light.

### SUMMARY

Embodiments of the present disclosure provide a display panel and a display device. The described technical solutions are as follows.

According to one aspect of the embodiments of the present disclosure, a display panel is provided. The display panel includes:
a base substrate;
a drive circuit, disposed on the base substrate and including a plurality of drive units, wherein the plurality of drive units include n rows of drive terminals, n being greater than or equal to two;
a plurality of sub-pixel clusters, disposed on the base substrate, wherein each of the sub-pixel clusters includes n rows of sub-pixels emitting light of m colors, the n rows of sub-pixels form n sub-pixel groups, each of the n sub-pixel groups including at least one sub-pixel of at least one color and adjacent sub-pixel groups including sub-pixels of different colors, wherein the n sub-pixel groups are in correspondence with the n rows of drive terminals respectively and row numbers of the drive terminals corresponding to the sub-pixel groups including the sub-pixels of a same color in different sub-pixel clusters is the same, the sub-pixels in the sub-pixel groups of a K^{th} row are electrically connected to the drive terminals of the K^{th} row, 1≤K≤n.

In some embodiments, n is 2, and the row numbers of the drive terminals corresponding to the sub-pixel groups including the sub-pixels of the same color in different sub-pixel clusters has a same parity (the row numbers are all odd or even numbers).

In some embodiments, each of the sub-pixels includes a light-emitting unit and a sub-pixel circuit, wherein the sub-pixel circuit is electrically connected to the light-emitting unit, and the sub-pixel circuit is further electrically connected to a drive terminal corresponding to the sub-pixel where the sub-pixel circuit is disposed.

In some embodiments, sub-pixel circuits of the n rows of sub-pixels are arranged in n rows on the base substrate, wherein the n rows of sub-pixel circuits correspond to the n rows of drive terminals respectively, and each of the n rows of sub-pixel circuits is electrically connected to a corresponding drive terminal.

In some embodiments, light-emitting units of the n rows of sub-pixels are arranged in n rows on the base substrate, wherein among the n rows of light-emitting units, an orthographic projection of each of the light-emitting units of an x^{th} row on the base substrate is overlapped with an orthographic projection of each of the sub-pixel circuits of an x^{th} row on the base substrate, 1≤x≤n;
a first sub-pixel group of the n sub-pixel groups includes a target sub-pixel, the light-emitting unit of the target sub-pixel is disposed in the x^{th} row, and the sub-pixel circuit of the target sub-pixel is disposed in an (x+a)^{th} row, 1≤x+a≤n, and a≠0.

In some embodiments, the display panel further includes: a plurality of connection structures, wherein the plurality of connection structures are disposed on the base substrate, a first connection structure of the plurality of connection structures is electrically connected to the light-emitting unit of the target sub-pixel disposed in the x^{th} row, and connected to the sub-pixel circuit of the target sub-pixel disposed in the (x+a)^{th} row, respectively.

In some embodiments, the light-emitting unit includes a first electrode, an electroluminescent layer, and a second electrode stacked sequentially along a direction away from the base substrate, wherein the first electrode is electrically connected to the first connection structure.

In some embodiments, the first connection structure and the first electrode are disposed in a same layer.

In some embodiments, the sub-pixel circuit includes a source-drain conductive structure, wherein the source-drain conductive structure includes a source-drain connection terminal, wherein a second end of the first connection structure is connected to the source-drain connection terminal.

In some embodiments, the sub-pixel circuit includes a source-drain conductive structure, wherein the first connection structure and the source-drain conductive structure are disposed in a same layer.

In some embodiments, the source-drain conductive structure includes a first source-drain conductive structure and a second source-drain conductive structure; wherein the first source-drain conductive structure and the second source-drain conductive structure are arranged in a direction away from the base substrate; and
one end of the first connection structure is connected to the second source-drain conductive structure and the other end of the first connection structure is electrically connected to the first electrode.

In some embodiments, the sub-pixel circuit includes a source-drain conductive structure and an insulating layer stacked sequentially in a direction away from the base substrate, wherein the source-drain conductive structure is disposed between the light-emitting unit and the base substrate, and the insulating layer is disposed between the source-drain conductive structure and the light-emitting unit;
wherein the first connection structure includes an adapter wire, and a first via is disposed in the insulating layer, wherein one end of the adapter wire is connected to the source-drain conductive structure through the first via in the insulating layer, and the other end of the adapter wire is connected to the light-emitting unit.

In some embodiments, m is 3, and the sub-pixels of three colors include red sub-pixels, blue sub-pixels, and green sub-pixels; and
the sub-pixels in one row include a plurality of pixels, wherein each of the plurality of pixels includes two green sub-pixels, one red sub-pixel, and one blue sub-pixel.

In some embodiments, n is 2, a first sub-pixel group among the two sub-pixel groups includes the red sub-pixels and the blue sub-pixels, and a second sub-pixel group among the two sub-pixel groups includes the green sub-pixels, the red sub-pixels and the blue sub-pixels are electrically connected to a first drive terminal among the two rows of the drive terminals, and the green sub-pixels are electrically connected to a second drive terminal among the two rows of the drive terminals.

In some embodiments, each of the sub-pixels includes the light-emitting unit and the sub-pixel circuit electrically connected to the light-emitting unit;
the display panel further includes a source-drain data signal line, wherein an orthographic projection of the source-drain data signal line on the base substrate is overlapped with an orthographic projection of at least one of a light-emitting unit of the red sub-pixel and a light-emitting unit of the blue sub-pixel on the base substrate.

In some embodiments, the display panel further includes a thin film transistor and a power line, the power line including a shielding block; wherein
the thin film transistor is disposed on the base substrate, the power line is disposed on a side of the thin film transistor away from the base substrate, and an orthographic projection of the shielding block on the base substrate is overlapped with an orthographic projection of the thin film transistor on the base substrate; and
an orthographic projection of a light-emitting unit of the green sub-pixel on the base substrate is overlapped with the orthographic projection of the shielding block on the base substrate.

In some embodiments, n is 3, a first sub-pixel group of the three sub-pixel groups includes the red sub-pixels, a second sub-pixel group of the three sub-pixel groups includes the green sub-pixels, and the second sub-pixel group of the three sub-pixel groups includes the blue sub-pixels;
wherein the red sub-pixels are connected to a first drive terminal of the three drive terminals, the green sub-pixels are connected to a second drive terminal of the three drive terminals, and the blue sub-pixels are connected to a third drive terminal of the three drive terminals.

In some embodiments, the sub-pixels on the base substrate form pixels of an RGBG structure; or
the sub-pixels on the base substrate form pixels of a GGRB structure.

In some embodiments, the light-emitting unit includes an organic light-emitting diode, and the drive circuit includes a gate driver on array circuit.

In some embodiments, sub-pixel circuits and light-emitting units of the n rows of sub-pixels are arranged in n rows respectively on the base substrate, the sub-pixel circuits of the n rows are electrically connected to the light-emitting units of the n rows respectively and the sub-pixel circuits are electrically connected to the drive terminals corresponding to the sub-pixel groups where the sub-pixel circuits are disposed.

According to another aspect of the embodiments of the present disclosure, a display device is provided. The display device includes a housing and the display panel, wherein the display panel is disposed on the housing.

### BRIEF DESCRIPTION OF DRAWINGS

For clearer descriptions of the technical solutions according to the embodiments of the present disclosure, the following briefly introduces the accompanying drawings required for describing the embodiments. Apparently, the accompanying drawings in the following description illustrate merely some embodiments of the present disclosure, and persons of ordinary skill in the art may still derive other drawings from these accompanying drawings without creative efforts.

FIG. 1 is a schematic diagram of each of light-emitting units in a display panel;

FIG. 2 is a schematic structural diagram of circuit connection in the display panel illustrated in FIG. 1;

FIG. 3 is a schematic structural diagram of a sub-pixel circuit in the circuit structure illustrated in FIG. 2;

FIG. 4 is a schematic diagram of a signal corresponding to the sub-pixel circuit illustrated in FIG. 3;

FIG. 5 is a schematic structural diagram of a display panel according to some embodiments of the present disclosure;

FIG. 6 is a schematic cross-sectional diagram of a partial structure in a display panel according to some embodiments of the present disclosure;

FIG. 7 is a schematic diagram of connection of a partial structure in a display panel according to some embodiments of the present disclosure;

FIG. 8 is a schematic structural diagram of a partial structure in a display panel according to some embodiments of the present disclosure;

FIG. 9 is a schematic structural diagram of another display panel according to some embodiments of the present disclosure;

FIG. 10 is a schematic structural diagram of a partial structure in the display panel illustrated in FIG. 9;

FIG. 11 is a schematic structural diagram of a partial structure of another display panel according to some embodiments of the present disclosure;

FIG. 12 is a schematic structural diagram of another display panel according to some embodiments of the present disclosure;

FIG. 13 is a schematic diagram of a partial structure of another display panel according to some embodiments of the present disclosure;

FIG. 14 is a schematic diagram of a partial structure of another display panel according to some embodiments of the present disclosure;

FIG. 15 is a schematic diagram of a partial structure of the display panel illustrated in FIG. 14;

FIG. 16 is a schematic structural diagram of a first gate conductive pattern in a display panel according to some embodiments of the present disclosure;

FIG. 17 is a schematic structural diagram of a second gate conductive pattern in a display panel according to some embodiments of the present disclosure;

FIG. 18 is a schematic structural diagram of an active layer pattern in a display panel according to some embodiments of the present disclosure;

FIG. 19 is a schematic structural diagram of a third gate conductive pattern in a display panel according to some embodiments of the present disclosure;

FIG. 20 is a schematic structural diagram of an interlayer media layer in a display panel according to some embodiments of the present disclosure;

FIG. 21 is a schematic structural diagram of a first source-drain conductive pattern in a display panel according to some embodiments of the present disclosure;

FIG. 22 is a schematic structural diagram of another display panel according to some embodiments of the present disclosure;

FIG. 23 is a schematic structural diagram of another display panel according to some embodiments of the present disclosure;

FIG. 24 is a schematic structural diagram of another display panel according to some embodiments of the present disclosure;

FIG. 25 is a schematic structural diagram of another display panel according to some embodiments of the present disclosure; and

FIG. 26 is a schematic structural diagram of another display panel according to some embodiments of the present disclosure.

Specific embodiments of the present disclosure have been illustrated by means of the above-described accompanying drawings, which are described in greater detail later hereafter. The accompanying drawings and textual descriptions are not intended to limit the scope of the concept of the present disclosure in any way, but rather to illustrate the concepts of the present disclosure for those skilled in the art by reference to specific embodiments.

### DETAILED DESCRIPTION

In order to make the purpose, technical solutions and advantages of the present disclosure clearer, the embodiments of the present disclosure will be described in further detail below in conjunction with the accompanying drawings.

At present, some display panels include gate driver on array (GOA) circuits, which can be configured to drive light-emitting units in the display panels to emit light, and the GOA circuits facilitate the reduction of a bezel of the display panel, thereby improving the aesthetics of display devices to which the display panels are applied and enhancing user experience.

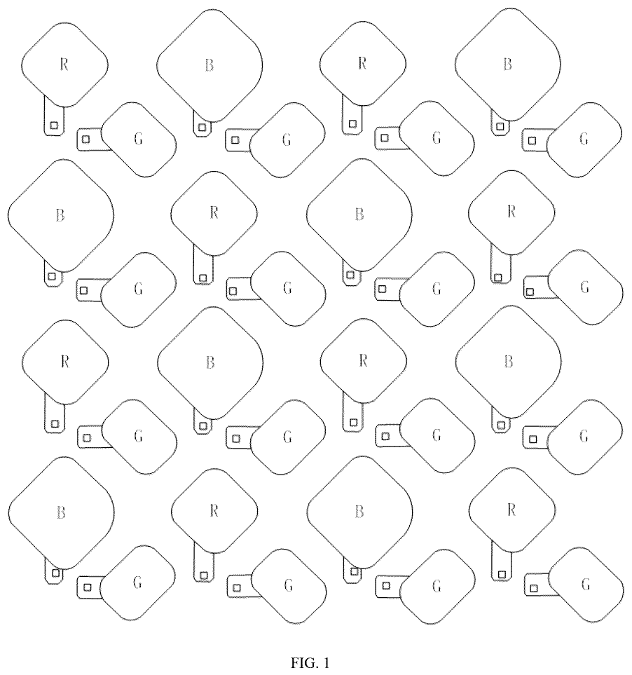

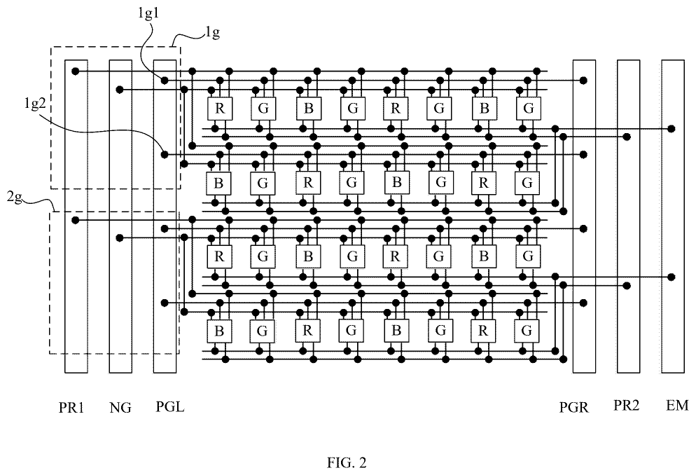

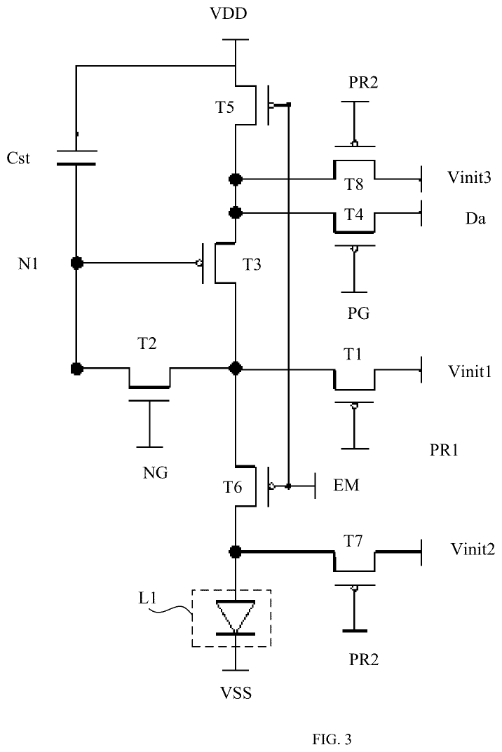

FIG. 1 is a schematic diagram of each of light-emitting units in a display panel, FIG. 2 is a schematic structural diagram of circuit connection in the display panel illustrated in FIG. 1, and FIG. 3 is a schematic structural diagram of a sub-pixel circuit in the circuit structure illustrated in FIG. 2.

Referring to FIGS. 1, 2, and 3, the display panel may include a base substrate, and pixel circuits and light-emitting units stacked sequentially on the base substrate. The pixel circuits may be connected to the GOA circuits at the edge of the display panel, and cooperate with the GOA circuits to drive the light-emitting units to emit light.

In FIG. 1, R represents an anode of a red light-emitting unit, G represents an anode of a green light-emitting unit, B represents an anode of a blue light-emitting unit. The display panel may include a plurality of rows of light-emitting units. In FIG. 2, R represents a red sub-pixel, G represents a green sub-pixel, B represents a blue sub-pixel, PGL represents a PGate on a left side, PGR represents a PGate on a right side, NG represents an Ngate, and EM represents an enable signal terminal.

In FIG. 3, L1 represents the light-emitting unit, which may include an organic light-emitting diode (OLED), NG represents the Ngate, PR1 represents a first reset signal line (P-Reset1), PR2 represents a second reset signal line (P-Reset2), Cst represents a storage capacitance, T1 to T8 represent eight thin-film transistors (TFT), Da represents a signal line (Data), PG represents the PGate, Vinit1 to Vinit3 represent three initial signal terminals, EM represents the enable signal terminal, and VDD and VSS represent two power supply terminals.

It is to be noted that the sub-pixel covered by the present disclosure may include a light-emitting unit and a sub-pixel circuit to which the light-emitting unit is connected.

Specifically, the pixel circuit may include a plurality of sub-pixel circuits, wherein each of the plurality of sub-pixel circuits may be disposed on a lower side of each of the light-emitting units (the lower side may be a side of the light-emitting unit close to the base substrate), and each of the light-emitting units may be in correspondence with the sub-pixel circuit on the lower side. The sub-pixel circuits may be in cooperation with the GOA circuits to drive the corresponding light-emitting units to emit light. FIG. 3 illustrates a circuit structure of an 8T1C structure, which is not limited in the embodiments of the present disclosure.

The GOA circuit may include a plurality of drive units, wherein each of the plurality of drive units is configured to drive two rows of sub-pixels. In FIG. 2, a drive unit 1g drives a first row of sub-pixels and a second row of sub-pixels, while a drive unit 2g drives a third row of sub-pixels and a fourth row of sub-pixels, which represents a “one-drive-multiple” structure of the GOA circuit. The structure simplifies the structure of the GOA circuit and thus reduces the bezel of the display panel.

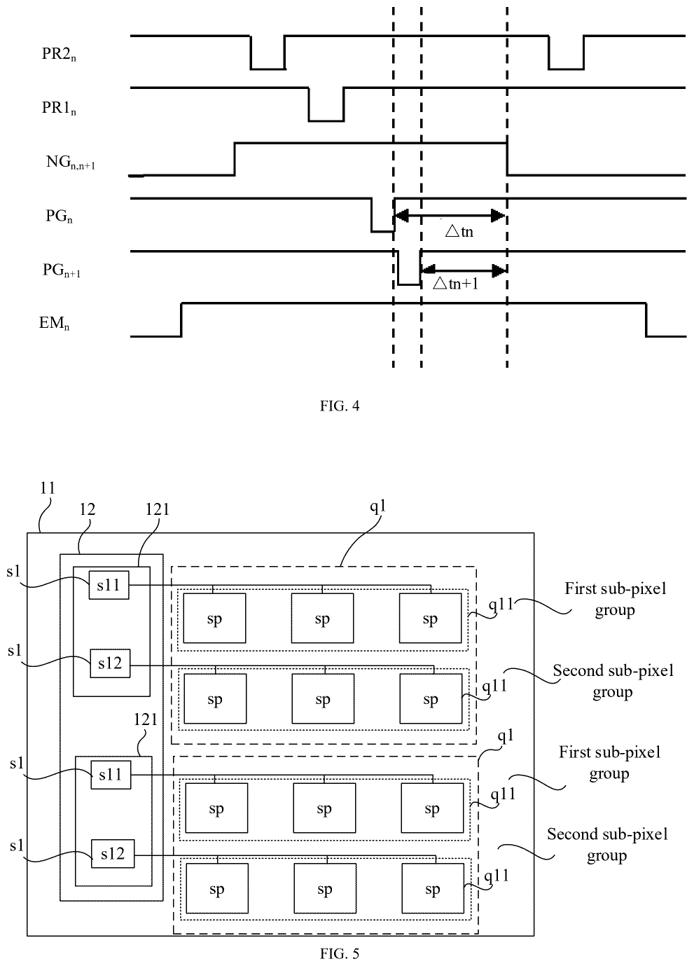

As devised by the applicant of the present disclosure, FIG. 4 is a schematic diagram of a signal corresponding to the sub-pixel circuit illustrated in FIG. 3. The sub-label of each label represents a row number where the structure represented by the label is located (which may refer to the row number of light-emitting units, or to the row number of sub-pixels). Exemplarily, PR2n represents a second reset signal line of the n^{th} row, and NG_{n,n+1} represents the n^{th} row of the Ngat, and the (n+1)^{th} row of the Ngate. PG represents a starting moment of compensation of the drive TFT (DTFT, the drive TFT may refer to T3 in FIG. 3) in each row, while NG represents a cut-off moment of compensation of the drive TFT in each row. As can be seen in FIG. 4, the compensation time of the drive TFT in the n^{th} row of sub-pixels is Δtn, the compensation time of the drive TFT in the (n+1)^{th} row of sub-pixels is Δtn+1, and the compensation time Δtn of the drive TFT in the n^{th} row of sub-pixels is greater than the compensation time Δtn+1 of the drive TFT in the (n+1)^{th} row of sub-pixels. As a result, the voltages of the N1 nodes of the drive TFT of the sub-pixels of the n^{th} row and the sub-pixels of the (n+1)^{th} row are different, which is manifested on the display by the difference in brightness between the sub-pixels of the n^{th} row and the sub-pixels of the (n+1)^{th} row, thereby resulting in the poor display effect of the display panel.

Some embodiments of the present disclosure provide a display panel and a display device capable of solving some of the problems as described above.

FIG. 5 is a schematic structural diagram of a display panel according to some embodiments of the present disclosure. The display panel includes:
a base substrate 11;
a drive circuit 12, disposed on the base substrate 11 and including a plurality of drive units 121, wherein the drive units 121 include n rows of drive terminals s1, n being greater than or equal to 2; and
a plurality of sub-pixel clusters q1, disposed on the base substrate 11, wherein each of the plurality of sub-pixel clusters q1 includes n rows of sub-pixels sp emitting m colors, the n rows of sub-pixels sp forming n sub-pixel groups q11, each of the n sub-pixel groups q11 including sub-pixels sp of at least one color and adjacent sub-pixel groups q11 of the n sub-pixel groups q11 including the sub-pixels sp of different colors, the n sub-pixel groups q11 corresponding to n rows of drive terminals s1 respectively, and the row numbers of drive terminals s1 corresponding to the sub-pixel groups q11 including the sub-pixels of the same color in different sub-pixel clusters q1 being the same, the sub-pixels in the sub-pixel group in the K^{th} row being electrically connected to the drive terminal in the K^{th} row, 1<K≤n, i.e., the sub-pixels sp in the sub-pixel group q11 being electrically connected to the corresponding drive terminal s1, wherein m may be greater than or equal to n.

Exemplarily, FIG. 5 includes one sub-pixel cluster q1 on an upper side, and the other sub-pixel cluster q1 on a lower side. In the sub-pixel cluster q1 on the upper side, a first sub-pixel group q11 in a first row includes green sub-pixels, and a second sub-pixel group q11 in a second row includes blue sub-pixels. In the sub-pixel cluster q1 on the lower side, the first sub-pixel group q11 in the first row (the first row in the sub-pixel cluster q1 on the lower side is a third row in the entire sub-pixel rows) includes the green sub-pixels, and the second sub-pixel group q11 in the second row (the second row in sub-pixel cluster q1 on the lower side is a fourth row in the entire sub-pixel rows) includes the blue sub-pixels. In the sub-pixel cluster q1 on the upper side, the first sub-pixel group q11 corresponds to the drive terminal s11 of the first row in the drive units 121, and the second sub-pixel group q11 corresponds to the drive terminal s12 of the second row in the drive units 121. Based on this, in the other sub-pixel cluster on the lower side, the first sub-pixel group corresponds to the drive terminal s11 of the first row in the drive units 121 connected to the other sub-pixel cluster, and the second sub-pixel group q11 corresponds to the drive terminal s12 of the second row in the drive units 121. In this way, a structure in which the sub-pixels including the same one or more colors in different sub-pixel clusters may be correspondingly connected to the drive terminal of the same row is implemented. The structure achieves the technical effect of reducing the difference in brightness of the sub-pixels of the same color in different sub-pixel clusters.

It is to be noted that the row numbers of drive terminals in different drive units in the drive circuit may be arranged independently. For example, the drive circuit includes ten drive units and each drive unit includes two drive terminals, and then the drive terminals in each drive unit are a first row of drive terminals and a second row of drive terminals.

The connection relationship of the structures is only briefly illustrated in FIG. 5, but the specific connection manner between the structures is not limited.

In summary, the display panel according to the embodiments of the present disclosure, by dividing a plurality of rows of sub-pixels into different sub-pixel groups based on different colors, each sub-pixel group includes the sub-pixels of at least one color and adjacent sub-pixel groups include sub-pixels of different colors, and by arranging a plurality of sub-pixel groups in one sub-pixel cluster in correspondence with a plurality of rows of drive terminals, the row numbers of sub-pixel groups including the sub-pixels of the same color in the different sub-pixel groups are the same, and the sub-pixels in the sub-pixel groups are electrically connected to the corresponding drive terminals. In the structure, in each sub-pixel cluster, the sub-pixels of the same color may be driven via the same row of drive terminals, such that the brightness difference among the light-emitting units in different sub-pixel clusters is reduced, and thus the problem of poor display effect of the display panel in the related technology is solved.

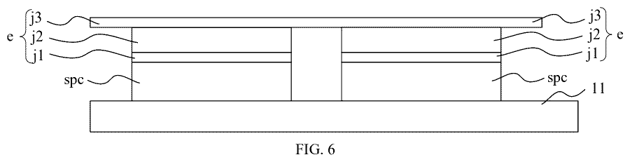

As illustrated in FIG. 6, FIG. 6 is a cross-sectional schematic diagram of a partial structure in a display panel according to some embodiments of the present disclosure. One sub-pixel may include a light-emitting unit e and a sub-pixel circuit spc, wherein the sub-pixel circuit spc is electrically connected to the light-emitting unit e, and the sub-pixel circuit spc is further electrically connected to a drive terminal corresponding to the sub-pixel where the sub-pixel circuit spc is disposed. Exemplarily, the drive terminal corresponding to a certain sub-pixel x1 is a first drive terminal, and then the sub-pixel circuit in the sub-pixel x1 is electrically connected to the first drive terminal. For the structure of the sub-pixel circuit, reference may be made to FIG. 3, or, reference may be made to some other display panels, which is not limited in the embodiments of the present disclosure.

In the display panel according to the embodiments of the present disclosure, in one sub-pixel sp, the sub-pixel circuit spc and the light-emitting unit e may be arranged sequentially in a direction away from the substrate 11, and an orthographic projection of the sub-pixel circuit spc on the substrate 11 may be overlapped with an orthographic projection of the light-emitting unit on the substrate 11 (FIG. 6 illustrates the structure), but the orthographic projection of the sub-pixel circuit spc on the substrate 11 may also be overlapped with the orthographic projection of the light-emitting unit on the substrate 11, which is not limited in the embodiments of the present disclosure.

Further, it is noted that in the display panel according to the embodiments of the present disclosure, the light-emitting unit in the sub-pixel may include an organic light-emitting diode (OLED), and the organic light-emitting diode may include an anode, a cathode, and an electroluminescent structure disposed between the anode and the cathode, the electroluminescent structure may include a plurality of film layers, such as a hole injection layer (HIL), an electron injection layer (EIL), a hole transport layer (HTL), an electron transport layer (ETL), an electron blocking layer (EBL), a hole blocking layer (HBL), an emissive layer (EML), or some or all of the other film layers. According to the different electroluminescent structures, the light-emitting unit may emit light of different colors. Exemplarily, the light-emitting unit may include a green light-emitting unit for emitting green light, a blue light-emitting unit for emitting blue light, and a red light-emitting unit for emitting red light, and correspondingly, the sub-pixel including the green light-emitting unit is a green sub-pixel, and the sub-pixel including the blue light-emitting unit is a blue subpixel. The display panel according to the embodiments of the present disclosure may also include the sub-pixels of other colors, such as white sub-pixels including white light-emitting units for emitting white light, or the like, which is not limited in the embodiments of the present disclosure.

A plurality of sub-pixels of different colors may form a pixel, and each pixel may serve as a basic display unit to display one color. Exemplarily, a pixel may include a blue sub-pixel, a red sub-pixel, and a green sub-pixel, such that light of different colors is obtained by the luminous intensities of the sub-pixels of different colors.

In addition, in the display panel according to the embodiments of the present disclosure, the drive circuit may include a gate driver on array circuit, the gate driver on array circuit may be disposed in a peripheral region of the display panel. The display panel may include a display region and a peripheral region disposed outside the display region, and the sub-pixels may be disposed in the display region. The sub-pixel circuits in the sub-pixels may be electrically connected to the gate driver on array circuit in the peripheral region.

It is to be noted that the electrical connection of two structures according to the embodiments of the present disclosure may refer to a connection of two structures in direct contact, or it may refer to an indirect connection between the two structures achieved through some other electrical devices such as a wire, a switch, a resistor, a diode, a circuit board or other various devices.

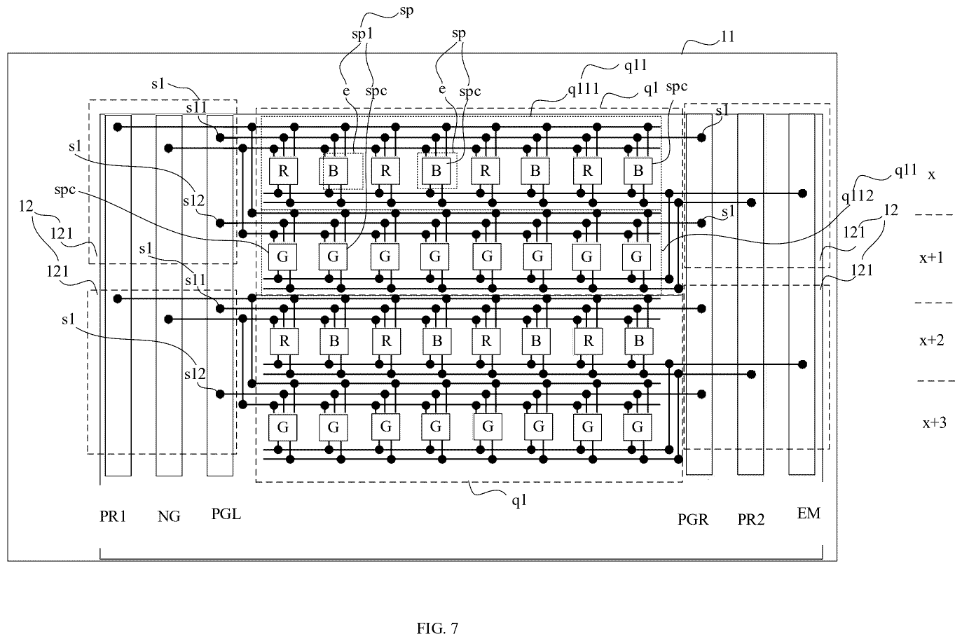

FIG. 7 is a connection schematic diagram of a partial structure in a display panel according to some embodiments of the present disclosure. Sub-pixel circuits spc of n rows of sub-pixels sp are arranged in n rows on a base substrate, the n rows of sub-pixel circuits spc correspond to n rows of drive terminals, respectively, and each row of sub-pixel circuits spc is electrically connected to a corresponding row of drive terminals s1. As the n rows of drive terminals correspond to n sub-pixel groups, with the structure, one row of sub-pixel circuits may be electrically connected to light-emitting units in one sub-pixel group. That is, one row of sub-pixel circuits may be constantly configured to drive light-emitting units of various preset colors.

Accordingly, a conventional sub-pixel circuit structure may be applied in the display panel according to the embodiments of the present disclosure. In the structure, a plurality of rows of sub-pixel circuits in one sub-pixel group may be electrically connected to a plurality of drive terminals s1 in one drive unit respectively. With this configuration, the connection is simplified, and thus no connection line is needed between the drive circuit and the sub-pixel circuit.

The display panel illustrated in FIG. 7 includes two drive units 121 and four rows of sub-pixel circuits spc (each solid square spc in FIG. 7 may represent one sub-pixel circuit spc). In the four rows of sub-pixel circuits spc, an x^{th} row of sub-pixel circuits and an (x+1)^{th} row of sub-pixel circuits spc form one sub-pixel group q11, and an (x+2)^{th} row of sub-pixel circuits and an (x+3)^{th} row of sub-pixel circuits form another sub-pixel group q11. Each drive unit 121 includes two rows of drive terminals s1, and the two rows of drive terminals s1 include a first row of drive terminals s11 and a second row of drive terminals s12. In the sub-pixel group q11 on the upper side, the x^{th} row of sub-pixel circuits spc is electrically connected to the first row of drive terminals s11, and the (x+1)^{th} row of sub-pixel circuits spc is electrically connected to the second row of drive terminals s12. The sub-pixel group q11 on the lower side has a similar structure.

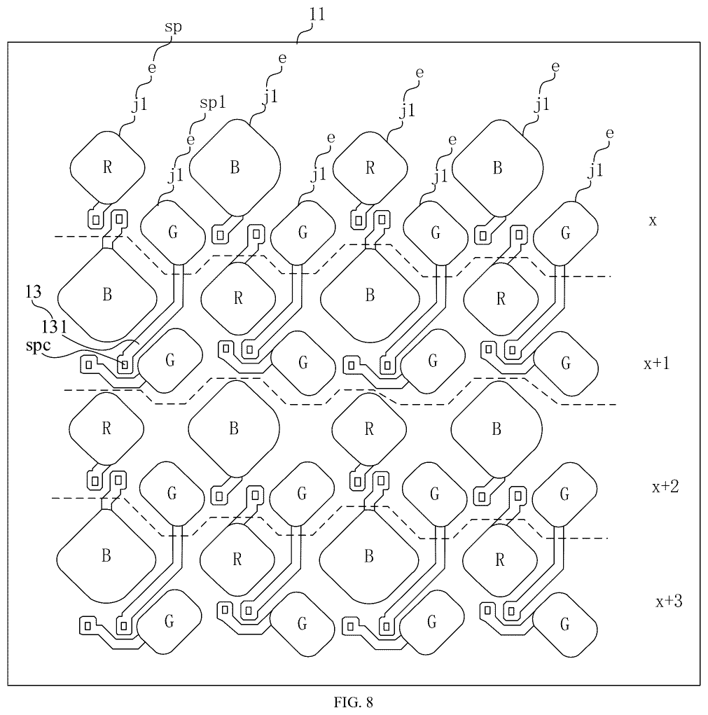

FIG. 8 is a schematic diagram of a partial structure of a display panel according to some embodiments of the present disclosure (sub-pixel circuits are not illustrated in FIG. 8 for the sake of clearly illustrating the light-emitting units). Referring to FIGS. 7 and 8, in an exemplary embodiment, the light-emitting units e of an n^{th} row of sub-pixels spc are arrayed in n rows on the base substrate 11. In an n^{th} row of light-emitting units e, an orthographic projection of an x^{th} row of light-emitting units e on the base substrate 11 is overlapped with an orthographic projection of the x^{th} row of sub-pixel circuits spc on the base substrate, and 1≤x≤n. That is, the light-emitting units and the sub-pixel circuits in the sub-pixels are arranged in a plurality of rows in a display panel according to the embodiments of the present disclosure, such that the display panel includes a plurality of rows of sub-pixel circuits, and a plurality of rows of light-emitting units. The light-emitting units are overlapped with the sub-pixel circuits below in the same row in the display panel.

In the related art, the light-emitting unit in one sub-pixel is electrically connected to an overlapping sub-pixel circuit that is in the same row underneath, which is not limited in the embodiments of the present disclosure. That is, the light-emitting unit in one sub-pixel may be electrically connected to the overlapping sub-pixel that is in the same row underneath, or may be electrically connected to the sub-pixel circuit in other rows.

It is further noted that the display panel according to the embodiments of the present disclosure includes a plurality of rows of sub-pixels, and the row in which one sub-pixel is disposed may be determined by the row in which the light-emitting unit in the sub-pixel is disposed. Exemplarily, the light-emitting unit of a sub-pixel is disposed in the x^{th} row, and the sub-pixel circuit of the sub-pixel is disposed in the (x+1)^{th} row, and then the sub-pixel is the sub-pixel in the x^{th} row.

In the current display panel, the colors of the sub-pixels included in each row of sub-pixels are the same. Exemplarily, as illustrated in FIG. 2, each row of sub-pixels includes the red sub-pixels, the green sub-pixels, and the blue sub-pixels. Accordingly, in the case that one sub-pixel group includes the green sub-pixels, and another sub-pixel group includes the red sub-pixels and the blue sub-pixels, one portion of the green sub-pixels in one sub-pixel group are electrically connected to the first row of the drive terminals 1g1 and another portion of the green sub-pixels are electrically connected to the second row of the drive terminals 1g2. In this way, it is impossible to implement a connection structure in which the two sub-pixel groups are electrically connected to the first row of drive terminals and the second row of drive terminals respectively.

In an exemplary embodiment, referring to FIGS. 7 and 8, the first sub-pixel group q11 of the n sub-pixel groups q11 includes a target sub-pixel sp1, the light-emitting unit e of the target sub-pixel sp1 is disposed in the x^{th} row, and the sub-pixel circuit spc of the target subpixel sp1 is disposed in an (x+a)^{th} row (illustrated in FIG. 7 as an example of a=1, but not limited thereto), 1≤x+a≤n, and a≠0. In the structure, the sub-pixel circuit spc of the target sub-pixel sp1 and the light-emitting unit e are disposed in different rows.

The sub-pixel circuit spc of the target sub-pixel sp1 is a sub-pixel circuit spc electrically connected to the drive terminal s12 corresponding to the target sub-pixel sp1. In this way, the electrical connection of the sub-pixels in the sub-pixel group and the corresponding drive terminals is implemented by adjusting the sub-pixel circuits to which the light-emitting units are connected.

In the implementation, the adjustment of lines in the display panel is reduced, for example, the display panel according to the embodiments of the present disclosure is implemented without adjustment of the GOA circuit and/or the connection lines between the GOA circuit and the sub-pixel circuits, such that the difficulty in designing the display panel according to the embodiments of the present disclosure is lowered, and the need for a new mask board is also reduced. In this way, the manufacturing cost of the display panel is lowered, and the manufacturing efficiency of the display panel is improved.

In the embodiments of the present disclosure, the sub-pixel circuits and the light-emitting units in different rows may be connected by a plurality of structures. In an exemplary embodiment, the display panel further includes a plurality of connection structures 13, the plurality of connection structures 13 are disposed on the base substrate 11, and a first connection structure 131 of the plurality of connection structures 13 is electrically connected to the light-emitting unit e of the target sub-pixel sp1 disposed in the x^{th} row, and the sub-pixel circuit spc of the target sub-pixel sp1 disposed in the (x+a)^{th} row (it should be noted that the sub-pixel circuit spc illustrated in FIG. 8 may refer to the sub-pixel circuit spc or to a position where the first connection structure 131 is connected to the sub-pixel circuit spc). As can be seen in FIG. 8, one end of the first connection structure 131 is connected to the light-emitting unit e of the target sub-pixel sp1 disposed in the x^{th} row, and the other end extends to the (x+a)^{th} row and is connected to the sub-pixel circuit spc of the target sub-pixel sp1 disposed in the (x+a)^{th} row. In this way, the electrical connection of the sub-pixel circuits and the light-emitting units of the different rows is thus implemented by the first connection structure 131.

As can be seen in FIG. 6 above, the light-emitting unit e includes a first electrode j1, an electroluminescent layer j2, and a second electrode j3 stacked sequentially in a direction away from the base substrate 11. The first electrode j1 may be electrically connected to the first connection structure 131. That is, the first connection structure 131 electrically connected to the light-emitting unit e according to the embodiments of the present disclosure may mean that the first connection structure 131 is electrically connected to the first electrode j1 in the light-emitting unit e. The first electrode j1 may be an anode of the light-emitting unit e.

In some embodiments, the first connection structure 131 and the first electrode j1 are disposed in the same layer. That is, the first connection structure 131 and the first electrode j1 may be of the same material, and are formed by a single patterning process, such that one patterning process can be saved, thereby improving the manufacturing efficiency of the display panel according to the embodiments of the present disclosure.

It is noted that the patterning process according to the embodiments of the present disclosure may include processes such as coating photoresist, exposure, developing, etching, or stripping photoresist.

In an exemplary embodiment, in each square representing a sub-pixel circuit spc in FIG. 7, R, G, B may refer to the colors of the light-emitting units e to which the sub-pixel circuit spc is electrically connected. In FIG. 8, R, G, B on each light-emitting unit e may refer to the color of the light emitted from the light-emitting unit e. As can be seen from FIGS. 7 and 8, the target sub-pixel sp1 may include a green sub-pixel, the light-emitting unit e of the green sub-pixel may be disposed in the x^{th} row, and the first connection structure 131 may be connected to the light-emitting unit e of the green sub-pixel and connected to the sub-pixel circuit spc of the green sub-pixel in the (x+a)^{th} row.

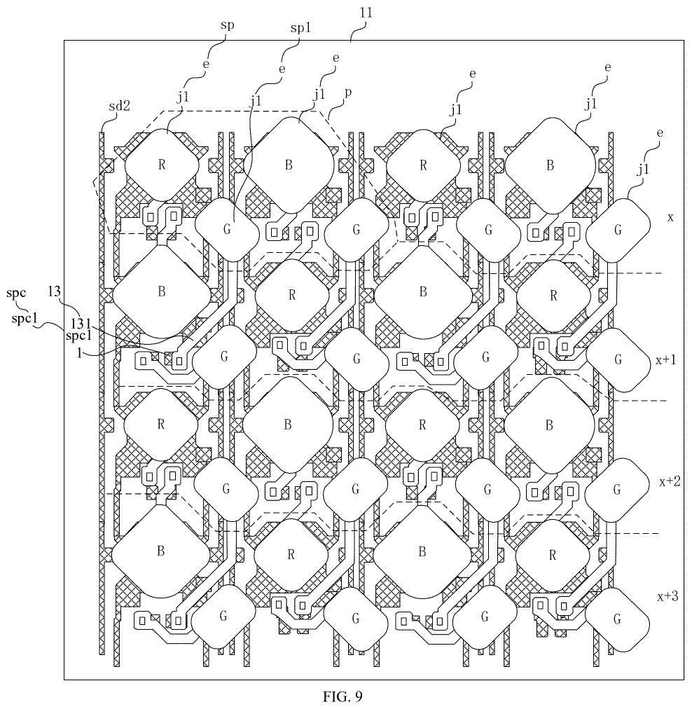

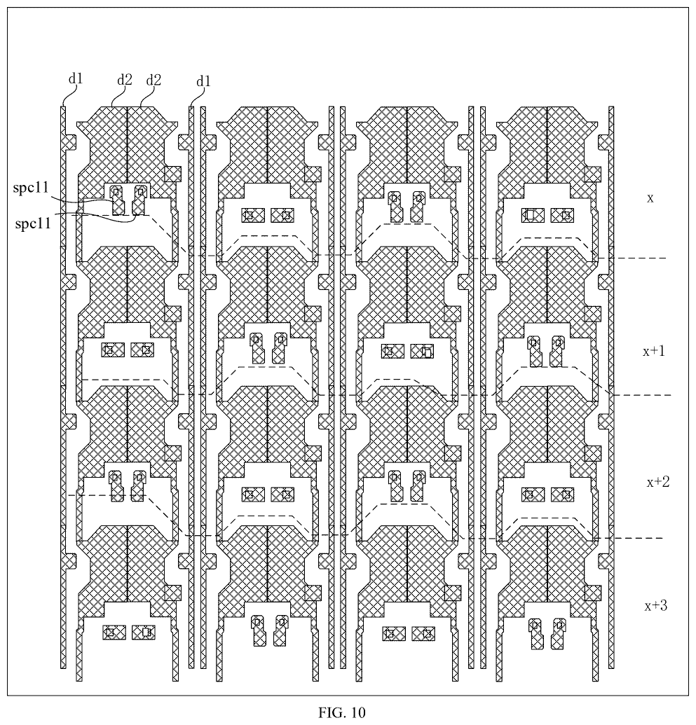

FIG. 9 is a schematic structural diagram of another display panel according to some embodiments of the present disclosure, and FIG. 10 is a schematic structural diagram of a partial structure in the display panel illustrated in FIG. 9. Referring to FIGS. 9 and 10, a sub-pixel circuit spc includes a source-drain conductive structure spc1, the source-drain conductive structure spc1 includes a source-drain connection terminal spc11, and a second terminal of the first connection structure 131 is connected to the source-drain connection terminal spc11. That is, the sub-pixel circuit spc is connected to the first connection structure 131 via the source-drain connection terminal spc11.

The display panel according to the embodiments of the present disclosure may include a source-drain conductive pattern, the source-drain conductive structure spc1 may be in the source-drain conductive pattern, and a plurality of source-drain conductive structures spc1 of a plurality of sub-pixel circuits in the display panel may form the source-drain conductive pattern.

In an exemplary embodiment, the display panel according to the embodiments of the present disclosure may include a first source-drain conductive pattern and a second source-drain conductive pattern sd2 disposed along a direction away from the base substrate. The source-drain conductive structure spc1 may refer to a partial structure of the second source-drain conductive pattern sd2 belonging to the sub-pixel circuit sdc.

The second source-drain conductive pattern sd2 may include structures such as a data signal line d1 (data), a power line d2 (VDD), and the source-drain connection terminal spc11.

In the above embodiments, the first connection structure and the first electrode in the light-emitting unit are fabricated in the same layer. However, in some other embodiments of the present disclosure, the first connection structure may also be fabricated in the same layer as other film layers.

In an exemplary embodiment, the sub-pixel circuit includes a source-drain conductive structure, and the first connection structure and the source-drain conductive structure are fabricated in the same layer. The source-drain conductive structure and the source-drain conductive pattern in the display panel may be fabricated in the same layer. That is, the first connection structure and the source-drain conductive pattern may be made of the same material, and the structure may be formed by a single patterning process, such that one patterning process is saved, thereby improving the manufacturing efficiency of the display panel according to the embodiments of the present disclosure.

In addition, when the source-drain conductive structure and the first electrode in the light-emitting unit are fabricated in the same layer, the electrical connection between the light-emitting unit and the sub-pixel circuit may be implemented by adjusting the structure of the source-drain conductive pattern, instead of changing the structure of the film layer in which the first electrode in the light-emitting unit is disposed.

In addition, the source-drain conductive structure includes a first source-drain conductive structure and a second source-drain conductive structure. The first source-drain conductive structure and the second source-drain conductive structure are arranged in a direction away from the base substrate. Similar to the above embodiments, the display panel of the embodiments of the present disclosure may include a first source-drain conductive pattern and a second source-drain conductive pattern along a direction away from the base substrate. The first source-drain conductive structure may belong to the first source-drain conductive pattern, the second source-drain conductive structure may belong to the second source-drain conductive pattern, and one end of the first connection structure is connected to the second source-drain conductive structure, and the other end of the first connection structure is electrically connected to the first electrode. That is, when the display panel includes a plurality of source-drain conductive patterns, the first connection structure and one of the source-drain conductive patterns closer to the first electrode are of the same layer structure (the second source-drain conductive pattern is disposed on a side of the first source-drain conductive pattern close to the first electrode, and thus the first connection structure and the second source-drain conductive pattern are disposed in a same layer). In this way, it is convenient to realize an electrical connection between the first connection structure and the first electrode above.

Exemplarily, an insulating layer is disposed between the second source-drain conductive pattern and the first electrode, such that the first connection structure can be electrically connected to the first electrode by passing through the insulating layer when the first connection structure and the second source-drain conductive pattern are fabricated in the same layer.

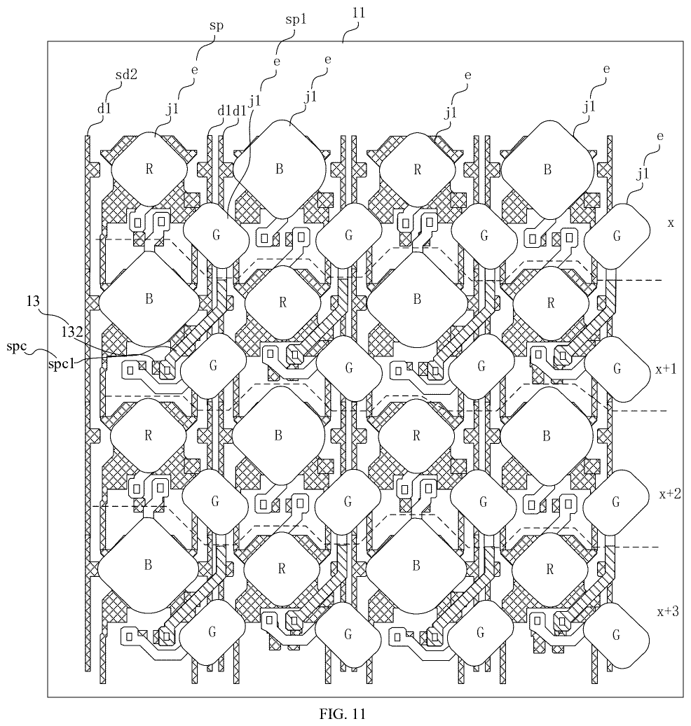

FIG. 11 is a schematic diagram of a partial structure of another display panel according to some embodiments of the present disclosure. The sub-pixel circuit spc includes a source-drain conductive structure spc1 and an insulating layer stacked sequentially in a direction away from the base substrate, wherein the source-drain conductive structure spc1 is disposed between a light-emitting unit e and a base substrate 11, and the insulating layer (not illustrated in FIG. 11) is disposed between the source-drain conductive structure spc1 and the light-emitting unit e.

The first connection structure 13 includes an adapter wire 132, and a first via is disposed in the insulating layer, one end of the adapter wire 132 is connected to the source-drain conductive structure spc1 through the first via in the insulating layer, and the other end of the adapter wire 132 is connected to the light-emitting unit e. In this way, the electrical connection of the light-emitting unit e and the sub-pixel circuit spc is implemented by elongating an adapter block for adapting the source-drain conductive pattern and the first electrode.

Referring to FIG. 9, in some embodiments, m is 3, and the three color sub-pixels sp include a red sub-pixel R, a blue sub-pixel B, and a green sub-pixel G. One row of sub-pixels sp includes a plurality of pixels p, each of which includes two green sub-pixels G, one red sub-pixel R, and a blue sub-pixel B. In FIG. 9, the first four sub-pixels sp in the x^{th} row (RGBG) may form one pixel.

In addition, it should be noted that the red sub-pixel R, the blue sub-pixel B, and the green sub-pixel G in FIGS. 8 and 9 are labelled as the light-emitting units e of the sub-pixels. Specifically, the red sub-pixel R, the blue sub-pixel B, and the green sub-pixel G are labeled as the first electrodes j1 in the light-emitting units e of the sub-pixels. That is, in FIGS. 8 and 9, positions where the sub-pixels are disposed are represented by the first electrodes j1 in the light-emitting units e, which is not limited in the embodiments of the present disclosure.

In an exemplary embodiment, n is 2. In this way, the parity of the row number of the drive terminals corresponding to the sub-pixel groups including the sub-pixels of the same color in the different sub-pixel clusters is the same. That is, the row number of the drive terminals electrically connected to the sub-pixel groups including the sub-pixels of the same color in a plurality of sub-pixel clusters is odd, or, is even. Exemplarily, referring to FIGS. 7 and 9, the first sub-pixel group q111 of the two sub-pixel groups q11 includes the red sub-pixels R and the blue sub-pixels B, the second sub-pixel group q112 of the two sub-pixel groups q11 includes the green sub-pixels G. The red sub-pixels R and the blue sub-pixels B are electrically connected to the first drive terminals s11 of the two rows of drive terminals s1, and the green sub-pixels G are electrically connected to the second drive terminals s12 of the two rows of drive terminals s1.

In the structure, in the display panel, the red sub-pixels R and the blue sub-pixels B are always electrically connected to the first drive terminals s11 (i.e., always electrically connected to the drive terminals of the odd-numbered rows), and the green sub-pixels G are always electrically connected to the second drive terminals s11 (i.e., always electrically connected to the drive terminals of the even-numbered rows), thereby reducing the difference in brightness between the sub-pixels of various colors in the different sub-pixel clusters.

In addition, as one row of sub-pixel circuits is electrically connected to the light-emitting units in one sub-pixel cluster in the embodiments of the present disclosure, and thus the red sub-pixels R and the blue sub-pixels B are always electrically connected to the first drive terminals s11, and where the plurality of drive terminals of the drive units correspond one-to-one to a plurality of rows of sub-pixel circuits in the sub-pixel clusters, in different sub-pixel clusters, the red sub-pixels R and the blue sub-pixels B are always electrically connected to the sub-pixel circuits of the same row number in the sub-pixel cluster. The green sub-pixels G are always electrically connected to the same row of sub-pixel circuits in the sub-pixel cluster. As the human eyes are more sensitive to the color green, the electrical connection of the green sub-pixels G and the sub-pixel circuits of the same row number in the sub-pixel clusters at all times enhances the perception of the human eyes, and thus enhances the user experience of the display device.

Exemplarily, when the first drive terminals s11 are electrically connected to the first rows of sub-pixel circuits in the sub-pixel clusters, and the second drive terminals s11 are electrically connected to the second rows of sub-pixel circuits in the sub-pixel clusters, the red sub-pixels R and the blue sub-pixels B are always electrically connected to the first rows of sub-pixel circuits in the sub-pixel clusters, and the green sub-pixels G are also always electrically connected to the second rows of sub-pixel circuits in the sub-pixel clusters. In the entire display panel, the red sub-pixels R and the blue sub-pixels B are always electrically connected to the sub-pixel circuits of the odd-numbered rows, and the green sub-pixels G are always electrically connected to the sub-pixel circuits of the even-numbered rows. Similarly, the red sub-pixels R and the blue sub-pixels B are always electrically connected to the sub-pixel circuits of the even-numbered rows, and the green sub-pixels G are always electrically connected to the sub-pixel circuits of the odd-numbered rows. In this way, the problem of brightness difference caused by the difference in the compensation time of the drive transistors illustrated in FIG. 4 is reduced or avoided.

In the above embodiments, as illustrated in FIGS. 9 and 11, the source-drain data signal line d1 is overlapped with the light-emitting unit e of the green sub-pixel G above, and thus the light-emitting unit e of the green sub-pixel G may be affected due to a signal jump of the source-drain data signal line d1, which may in turn affect the display effect of the display panel.

FIG. 12 is a schematic structural diagram of another display panel according to some embodiments of the present disclosure. The display panel further includes a source-drain data signal line d1, wherein an orthographic projection of the source-drain data signal line d1 on a base substrate 11 is overlapped with an orthographic projection of at least one of the light-emitting unit e of the red sub-pixel R and the light-emitting unit e of the blue sub-pixel B on the base substrate 11. That is, at least one of the light-emitting unit e of the red sub-pixel R and the light-emitting unit e of the blue sub-pixel B is disposed above the source-drain data signal line d1. Specifically, a first electrode j1 of the light-emitting unit e of the red sub-pixel R, and/or, a first electrode j1 of the light-emitting unit e of the blue sub-pixel B, is disposed above the source-drain data signal line d1, wherein the first electrode j1 may be an anode. Compared to the scheme of providing the light-emitting unit e of each green sub-pixel G above the source-drain data signal line d1, the scheme according to the embodiments of the present disclosure that at least one of the light-emitting unit e of the red sub-pixel R and the light-emitting unit e of the blue sub-pixel B above the source-drain data signal line d1 prevents the light-emitting units e of some or all of the green sub-pixels G from being affected by a signal jump of the source-drain data signal lines d1.

In an exemplary embodiment, the display panel further includes a thin film transistor (not illustrated in FIG. 11) and a power cord d2, wherein the power cord d2 includes a shielding block d21 on the power cord d2. The thin film transistor is disposed on the base substrate 11, the power cord d2 is disposed on a side of the thin film transistor away from the base substrate 11, and an orthographic projection of the shielding block d21 on the base substrate 11 is overlapped with an orthographic projection of the thin film transistor on the base substrate 11. The potential of the power line d2 is stable, and thus the shielding block d21 on the power line d2 can be configured to block the thin-film transistor. For example, a channel region of the thin-film transistor is blocked to prevent the thin-film transistor from being affected by other structures above the shielding block d21, thereby improving the stability of the thin-film transistor and further improving the display effect of the display panel.

It is noted that a plurality of thin film transistors may be included in the display panel. The orthographic projection of the shielding block d21 on the base substrate 11 may be overlapped with the orthographic projection of one or more of the thin film transistors, such that the stability of one or more of the thin film transistors is enhanced.

An orthographic projection of the light-emitting unit e of the green sub-pixel G on the base substrate 11 is overlapped with the orthographic projection of the shielding block d21 on the base substrate 11, i.e. the light-emitting unit e of the green sub-pixel G is disposed above the shielding block d21. Specifically, the first electrode j1 of the light-emitting unit e of the green sub-pixel G is disposed above the shielding block d21, wherein the first electrode j1 may be an anode.

Compared to the source-drain data signal line d1, the potential of the shielding block d21 is stable, and by arranging the light-emitting unit e of the green sub-pixel G above the shielding block d21, the light-emitting unit e of the green sub-pixel G may be prevented from being affected by a signal jump of the source-drain data signal line d1, thereby improving the display effect of the display panel.

In addition, for details of a portion of the line connection structure of the display panel illustrated in FIG. 12, reference may be made to FIG. 7, which is not limited in the embodiments of the present disclosure.

As can be seen in FIGS. 9 and 12, the display panel illustrated in FIG. 12 is approximately the display panel illustrated in FIG. 9 in which the light-emitting units e are entirely arranged leftward by a pitch of one sub-pixel (that is, compared to arrangement of the light-emitting units in the display panel illustrated in FIG. 9, the light-emitting units in the display panel illustrated in FIG. 12 are shifted leftward by a pitch of one sub-pixel). Correspondingly, the shape of the connection structure may be adjusted in the display panel illustrated in FIG. 12, but the connection relationship of the connection structure may be similar to that according to the embodiments described above. Exemplarily, the first connection structures 131 of the plurality of connection structures 13 are electrically connected to the light-emitting units e, which are disposed in the x^{th} row of the target subpixels sp1, and connected to the sub-pixel circuits spc, which is disposed in the (x+a)^{th} row of the target sub-pixels sp1, respectively (it should be noted that the sub-pixel circuit spc illustrated in FIG. 12 may refer to the sub-pixel circuit spc, or refer to a position where the first connection structure 131 is connected to the sub-pixel circuit spc). As can be seen in FIG. 12, one end of the first connection structure 131 is connected to the light-emitting unit e in the x^{th} row of the target sub-pixel sp1, and the other end of the first connection structure 131 extends to the (x+1)^{th} row and is connected to the sub-pixel circuit spc of the (x+1)^{th} row of the target sub-pixel sp1. In this way, the electrical connection of the sub-pixel circuits and the light-emitting units of the different rows is thus implemented by the first connection structure 131.

As can be seen in FIG. 6 above, the light-emitting unit e includes the first electrode j1, the electroluminescent layer j2, and the second electrode j3 stacked sequentially in a direction away from the base substrate 11, and the first electrode j1 may be electrically connected to the first connection structure 131. Correspondingly, in the embodiments of the present disclosure, the first connection structure 131 being electrically connected to the light-emitting unit e may mean that the first connection structure 131 is electrically connected to the first electrode j1 in the light-emitting unit e. The first electrode j1 may be an anode of the light-emitting unit e.

For the display panel illustrated in FIG. 12, the first connection structure 131 and the first electrode j1 may be disposed in the same layer. That is, the first connection structure 131 and the first electrode j1 may be of the same material, and the structure is formed by a single patterning process, such that one patterning process can be saved, thereby improving the manufacturing efficiency of the display panel according to the embodiments of the present disclosure.

In FIG. 12, R, G, B marked on each light-emitting unit e may refer to a color of light emitted by the light-emitting unit e. Exemplarily, the target sub-pixel sp1 may include one or more red sub-pixels, the light-emitting unit e of the red sub-pixel may be disposed on the x^{th} row, and the first connection structure 131 may be connected to the light-emitting unit e of the red sub-pixel and the sub-pixel circuit spc of the red sub-pixel the (x+1)^{th} row. The display panel according to the embodiments of the present disclosure may include a source-drain conductive pattern, the source-drain conductive structure spc1 may belong in the source-drain conductive pattern, and a plurality of source-drain conductive structures spc1 of a plurality of sub-pixel circuits in the display panel may form the source-drain conductive pattern.

Alternatively, the display panel according to the embodiments of the present disclosure may include a first source-drain conductive pattern and a second source-drain conductive pattern sd2 disposed along a direction away from the base substrate, and the source-drain conductive structure spc1 may refer to a portion of the second source-drain conductive pattern sd2 belonging to the sub-pixel circuit sdc.

The second source-drain conductive pattern sd2 may include structures such as a data signal line d1 (data), a power line d2 (VDD), and a source-drain connection end spc11.

In the above embodiments, the first connection structure and the first electrode in the light-emitting unit are disposed in the same layer, but in the embodiments of the present disclosure, the first connection structure may also be disposed in other layers, such as a source-drain conductive pattern, which is not limited in the embodiments of the present disclosure.

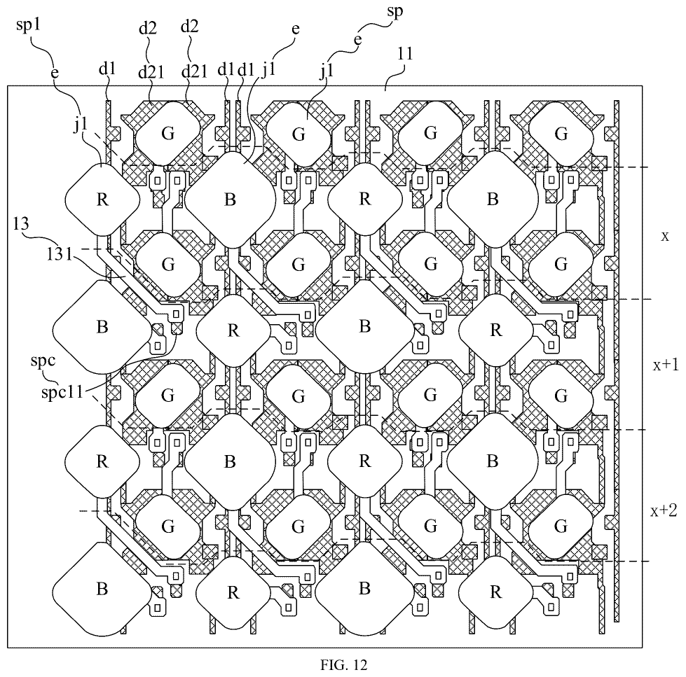

FIG. 13 is a schematic diagram of a partial structure of another display panel according to some embodiments of the present disclosure. A sub-pixel circuit spc includes a source-drain conductive structure spc1 and an insulating layer stacked sequentially in a direction away from a base substrate, wherein the source-drain conductive structure spc1 is disposed between a light-emitting unit e and the base substrate 11, and the insulating layer (not illustrated in FIG. 11) is disposed between the source-drain conductive structure spc1 and the light-emitting unit e.

The first connection structure 13 includes an adapter wire 132, and a first via is disposed in the insulating layer, one end of the adapter wire 132 is connected to the source-drain conductive structure spc1 through the first via in the insulating layer, and the other end of the adapter wire 132 is connected to the light-emitting unit e of the target sub-pixel. That is, the light-emitting units in the sub-pixels are shifted as a whole, such that an orthographic projection of the light-emitting unit e of a green sub-pixel G on the base substrate 11 is overlapped with an orthographic projection of a shielding block d21 on the base substrate 11. An orthographic projection of a source-drain data signal line d1 on the base substrate 11 is overlapped with an orthographic projection of the light-emitting unit e of a red sub-pixel R, and an orthographic projection of the light-emitting unit e of a blue sub-pixel B on the base substrate, it is still possible to electrically connect the light-emitting unit e to the sub-pixel circuit spc by elongating the adapter block for adapting the source-drain conductive pattern and the first electrode.

In the above embodiments, the sub-pixels sp on the base substrate 11 form pixels of an RGBG structure. The RGBG structure is a structure of pixels, also known as diamond-arranged pixels.

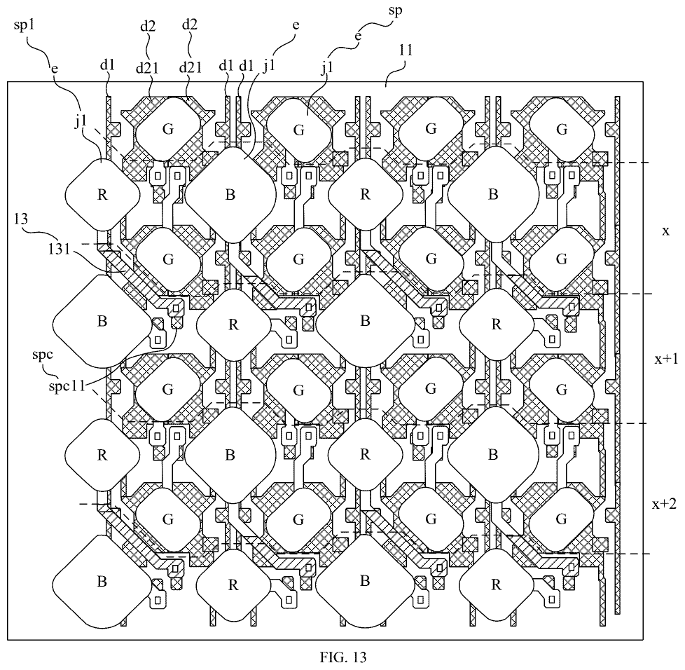

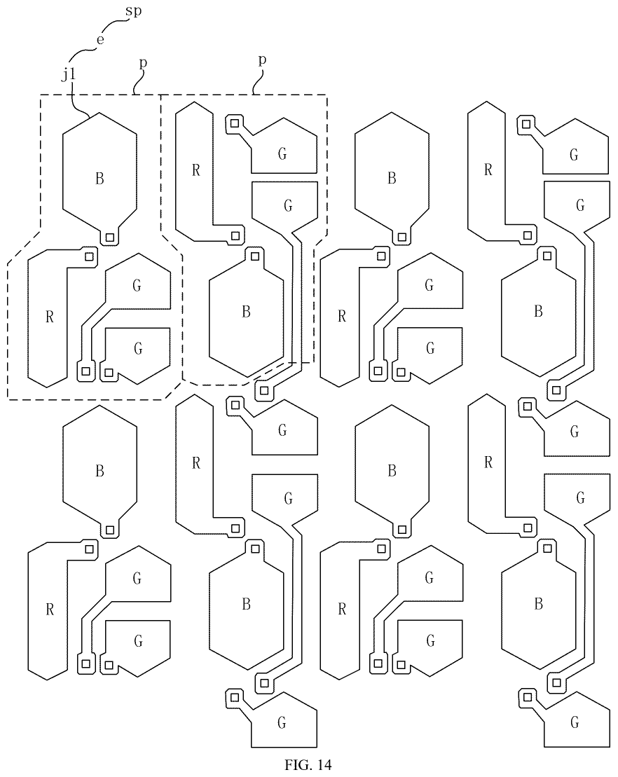

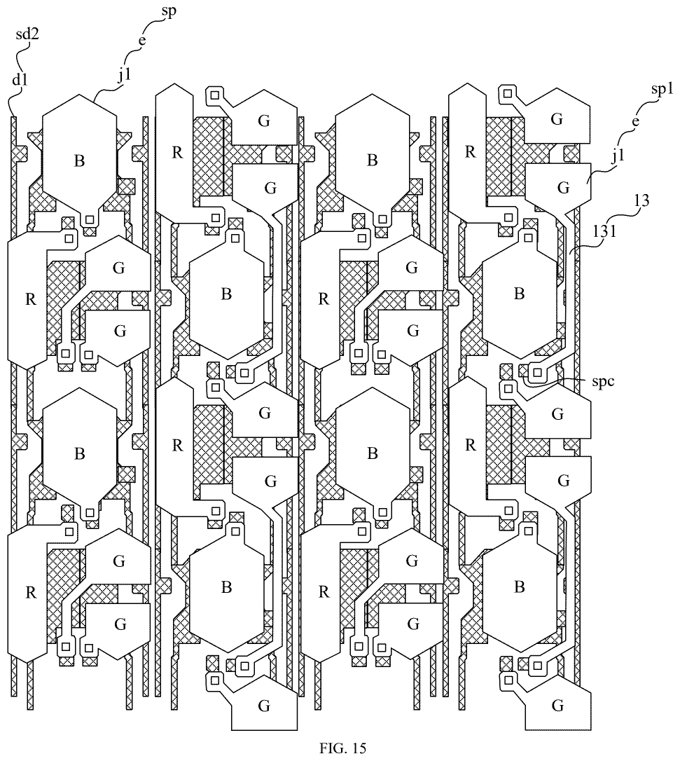

The sub-pixels sp in the display panel according to the embodiments of the present disclosure may also form a pixel of other structures. Exemplarily, FIG. 14 is a schematic diagram of a partial structure of another display panel according to some embodiments of the present disclosure, and FIG. 15 is a schematic diagram of a partial structure in the display panel illustrated in FIG. 14. Referring to FIGS. 14 and 15, the sub-pixels sp on a base substrate 11 forms a pixel p of a GGRB structure. The GGRB is a structure of pixels, and the structure can enhance the color performance of the pixels and enhance the display effect of the display panel. In FIGS. 14 and 15, a red sub-pixel R, a blue sub-pixel B, and a green sub-pixel G are labeled with the light-emitting unit e of the sub-pixel. Specifically, the red sub-pixel R, the blue sub-pixel B, and the green sub-pixel G are labeled with a first electrode j1 of the light-emitting unit e of the sub-pixel. That is, the first electrode j1 of the light-emitting unit e is configured to denote a position of the sub-pixel in FIGS. 14 and 15, which is not limited in the embodiments of the present disclosure. In addition, a second source-drain conductive pattern sd2 in the display panel is illustrated in FIG. 9, and the second source-drain conductive pattern sd2 may be disposed between the first electrode j1 and the base substrate.

Structures not illustrated in the display panel illustrated in FIGS. 14 and 15 may be referred to other embodiments, schematic diagrams of the connection structures for some exemplary lines may be referred to FIG. 7, and the structure of the second source-drain conductive pattern sd2 may be referred to FIG. 10, etc., and the embodiments of the present disclosure are not repeated herein.

The first connection structures 131 in the plurality of connection structures 13 are electrically connected to the light-emitting units e of the target sub-pixels sp1 disposed in the x^{th} row and the sub-pixel circuits spc of the target sub-pixels sp1 disposed in the (x+a)^{th} row, respectively (it should be noted that the sub-pixel circuit spc illustrated in FIG. 15 may refer to the sub-pixel circuit spc, or may refer to a position where the first connection structure 131 is connected to the sub-pixel circuit spc). As can be seen in FIG. 15, one end of the first connection structure 131 is connected to the light-emitting unit e of the target sub-pixel sp1 disposed in the x^{th} row, and the other end of the first connection structure 131 extends to the (x+1)^{th} row and is connected to the sub-pixel circuit spc of the target sub-pixel sp1 disposed in the (x+1)^{th} row. In this way, the electrical connection of the sub-pixel circuits and the light-emitting units of the different rows is thus implemented by the first connection structures 131.

The target sub-pixel sp1 according to the present disclosure may refer to a sub-pixel in the display panel in which the light-emitting unit and the sub-pixel circuit are disposed in different rows. As illustrated in FIG. 15, a structure in which the light-emitting unit e of the green sub-pixel G, which is the target sub-pixel sp1, is connected to the sub-pixel circuit spc through the first connection structure 131, which is not limited in the embodiments of the present disclosure.

The display panel according to the above embodiments is to realize a connection relationship in which the sub-pixels in the sub-pixel group are electrically connected to the corresponding drive terminals by adjusting the sub-pixel circuit to which the light-emitting unit are connected, but the display panel according to the embodiments of the present disclosure can realize the connection relationship in other ways.

In an exemplary embodiment, the sub-pixel circuits of n rows of sub-pixels and light-emitting units are arranged in n rows on the base substrate, the n rows of sub-pixel circuits are electrically connected to the n rows of light-emitting units, and the sub-pixel circuits are electrically connected to the drive terminals corresponding to the sub-pixel group where the sub-pixel circuits are disposed. In the structure, the connection relationship of the sub-pixel circuits and the light-emitting units may remain unchanged, and the electrical connection of the sub-pixels in the sub-pixel group and the corresponding drive terminals is implemented by adjusting connection structures of the sub-pixel circuits and the drive terminals of the drive units in the drive circuits (e.g., GOA circuits).

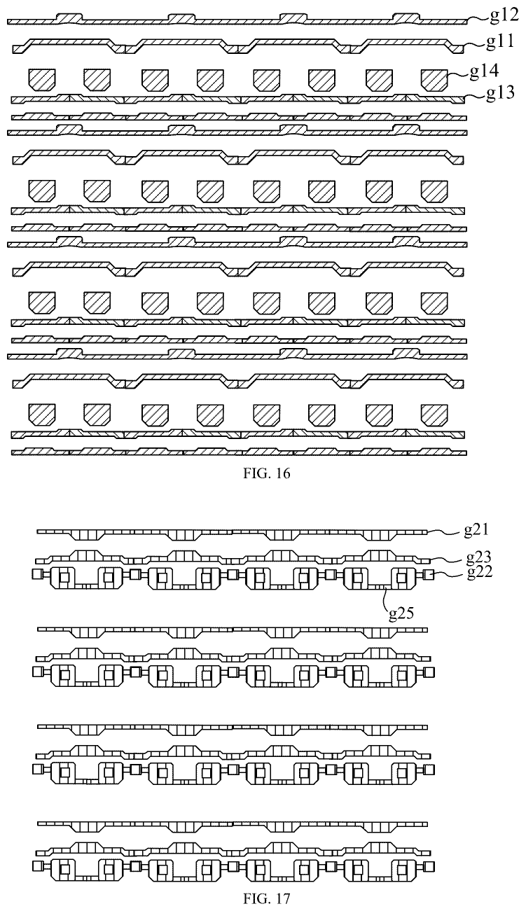

The display panel according to the embodiments of the present disclosure may also include some other structures, such as a first source-drain conductive pattern (SD1), an active layer pattern, a first gate conductive pattern (Gate1), a second gate conductive pattern (Gate2), a third gate conductive pattern (Gate3), and an interlayer dielectric layer (ILD), or the like, which are illustrated in the following by means of the accompanying drawings. Exemplarily, FIG. 16 is a schematic structural diagram of the first gate conductive pattern according to some embodiments of the present disclosure. Referring to FIG. 16, the first gate conductive pattern (Gate1) may include structures such as a Pgate signal line g11, a Vinit1 signal line g12, an EM signal line g13, and a first plate g14 of a storage capacitor.

FIG. 17 is a schematic structural diagram of a second gate conductive pattern in a display panel according to some embodiments of the present disclosure. Referring to FIG. 17, the second gate conductive pattern may include a gate control signal line g21 (e.g., an Nreset signal line (bottom gate)), a second plate g22 of a storage capacitor, a gate control signal line g23 (e.g., an Ngate signal line (bottom gate)), and a plate connection line g25, and other structures.

FIG. 18 is a schematic structural diagram of an active layer pattern in a display panel according to some embodiments of the present disclosure. Referring to FIG. 18, the active layer includes an active layer structure y1 disposed in a plurality of sub-pixels, and a material of the active layer structure y1 may include indium gallium zinc oxide (IGZO).

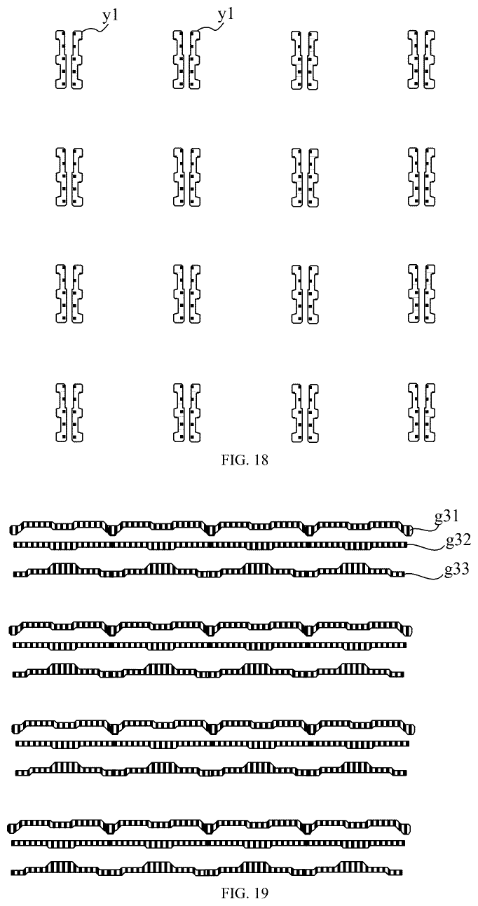

FIG. 19 is a schematic structural diagram of a third gate conductive pattern in a display panel according to some embodiments of the present disclosure. Referring to FIG. 19, the third gate conductive pattern (Gate3) may include a Vinit3 signal line g31, a gate control signal line g32 (e.g., an Nreset signal line (top gate)), and a gate control signal line g33 (e.g., an Ngate signal line (top gate)).

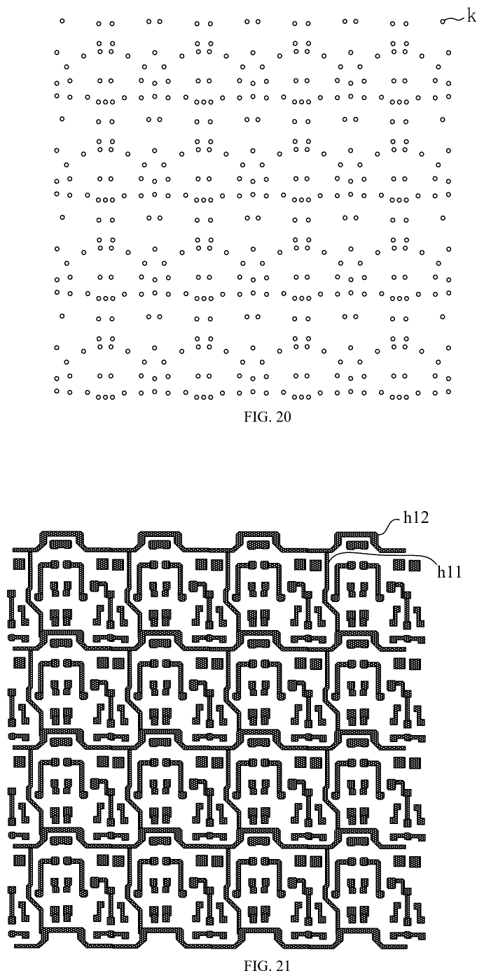

FIG. 20 is a schematic structural diagram of an interlayer dielectric layer in a display panel according to some embodiments of the present disclosure. Referring to FIG. 20, the interlayer dielectric layer (ILD) may include a plurality of vias k for connecting the structures of the upper and lower layers of the interlayer dielectric layer (ILD). For example, the vias may be configured to connect a third gate conductive pattern to a first source-drain conductive pattern.

FIG. 21 is a schematic structural diagram of a first source-drain conductive pattern in a display panel according to some embodiments of the present disclosure. Referring to FIGS. 21, h11 and h12 in the first source-drain conductive pattern (SD1) are Vinit2 signal lines, and the other connection structure may include an adapter wire.

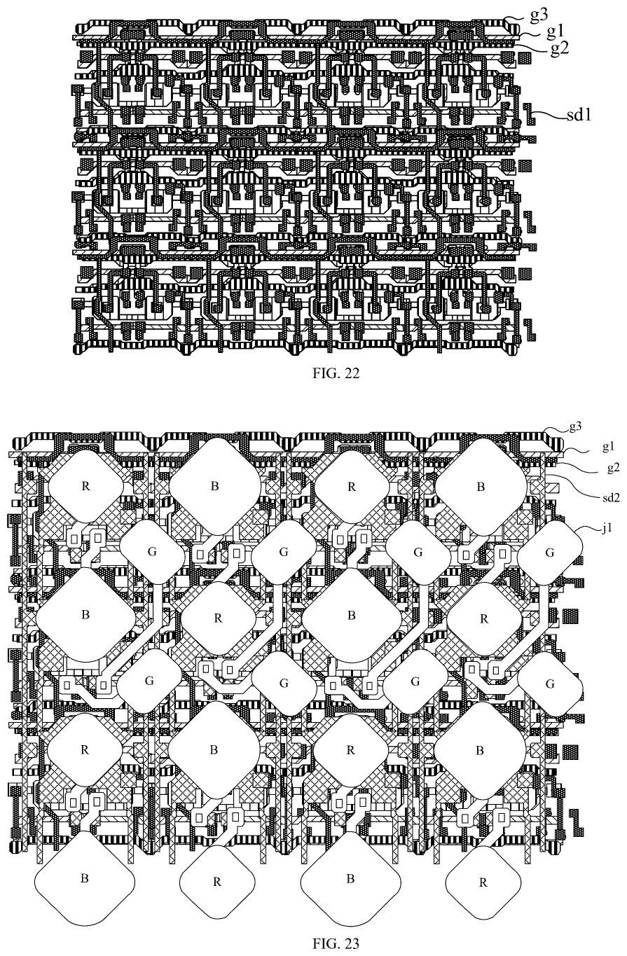

FIG. 22 is a schematic structural diagram of another display panel according to some embodiments of the present disclosure. The display panel includes the film layer structures described above, such as the first gate conductive pattern g1, the second gate conductive pattern g2, the active layer pattern, the third gate conductive pattern g3, the interlayer dielectric layer, and the first source-drain conductive pattern sd1.

The structures such as the second source-drain conductive pattern and the first electrode included in the above embodiments of the present disclosure may be disposed above the first source-drain conductive pattern sd1.

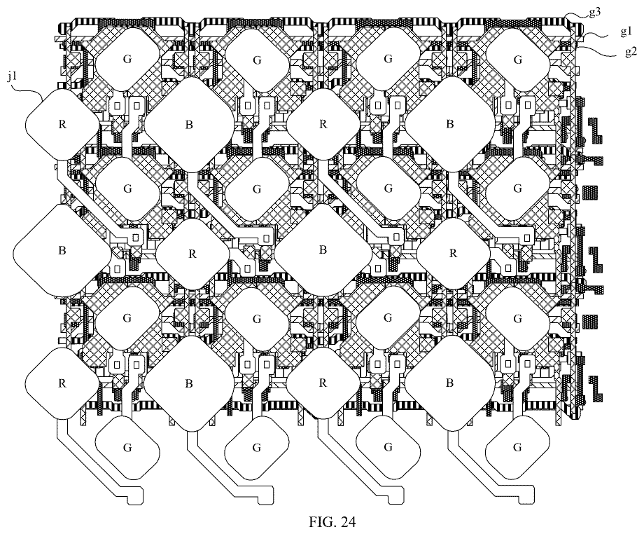

Exemplarily, referring to FIG. 23, FIG. 23 is a schematic structural diagram of another display panel according to some embodiments of the present disclosure. The display panel illustrated in FIG. 23 may be a display panel obtained by adding the second source-drain conductive pattern and the first electrode in the display panel illustrated in FIG. 9 on the basis of FIG. 22.

Referring to FIG. 24, FIG. 24 is a schematic structural diagram of another display panel according to some embodiments of the present disclosure. The display panel illustrated in FIG. 24 may be a display panel obtained by adding the second source-drain conductive pattern and the first electrode in the display panel illustrated in FIG. 12 on the basis of FIG. 22.

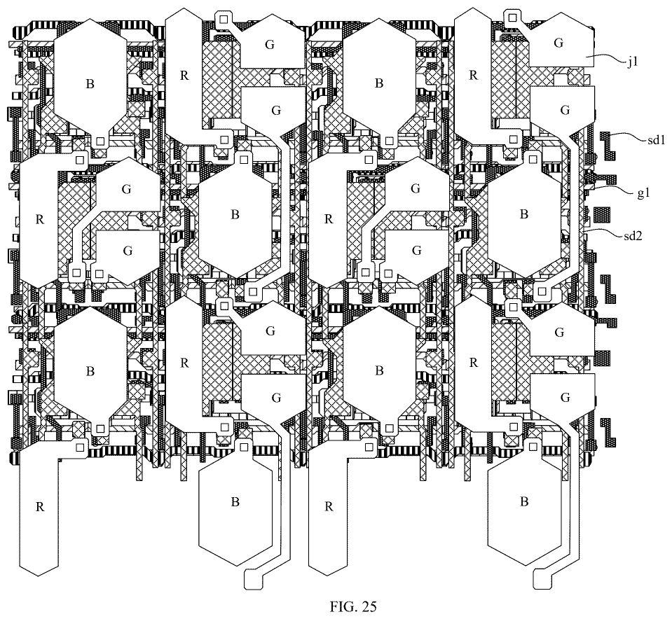

Referring to FIG. 25, FIG. 25 is a schematic structural diagram of another display panel according to some embodiments of the present disclosure. The display panel illustrated in FIG. 25 may be a display panel obtained by adding the second source-drain conductive pattern and the first electrode in the display panel illustrated in FIG. 15 on the basis of FIG. 22.

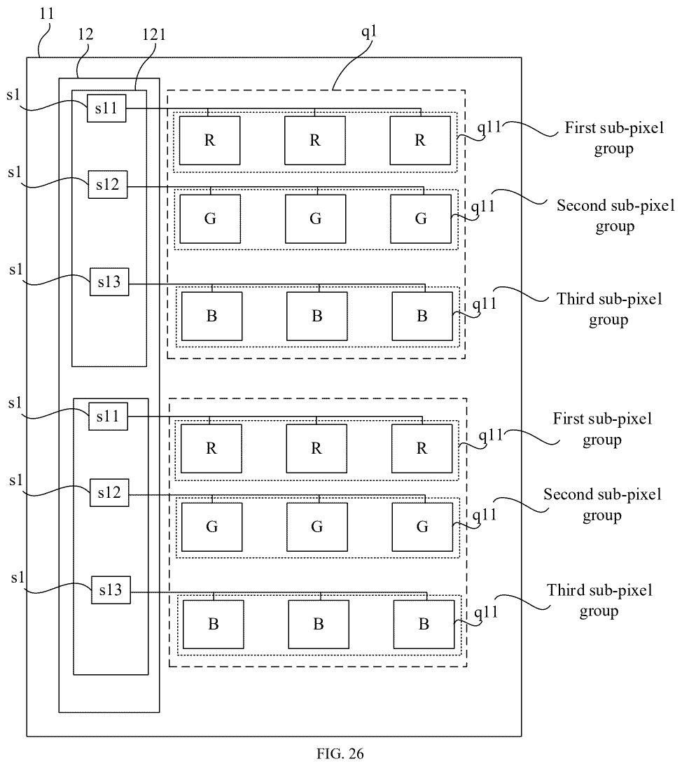

Furthermore, in the display panel according to the above embodiments, n is 2, but in the display panel according to the embodiments of the present disclosure, n may also be other values. Exemplarily, as illustrated in FIG. 26, FIG. 26 is a schematic structural diagram of another display panel according to some embodiments of the present disclosure, wherein n is 3, the first sub-pixel group among the three sub-pixel groups includes a red sub-pixel R, the second sub-pixel group among the three sub-pixel groups includes a green sub-pixel G, and the third sub-pixel group of the three sub-pixel groups includes a blue sub-pixel B. In this way, the sub-pixels of the three colors are respectively divided into three sub-pixel groups, each sub-pixel group including the sub-pixels of only one color.

The red sub-pixel R is connected to a first drive terminal s11 of three drive terminals, the green sub-pixel G is connected to a second drive terminal s12 of three drive terminals, and the blue sub-pixel B is connected to a third drive terminal s13 of three drive terminals.

In the structure, the light-emitting units connected to a row of sub-pixel circuits in the display panel include the light-emitting units of only one color. In the case where a plurality of rows of sub-pixel circuits in each sub-pixel cluster correspond one-to-one to a plurality of rows of drive terminals in the drive units, the sub-pixels of the same color are always electrically connected to the drive terminals in the same row, such that the difference in brightness of the light-emitting units of various colors is reduced and thus the display effect of the display panel is improved.

In summary, in the display panel according to the embodiments of the present disclosure, by dividing a plurality of rows of sub-pixels into different sub-pixel groups based on different colors, each sub-pixel group includes the sub-pixels of at least one color and adjacent sub-pixel groups include sub-pixels of different colors, and by making a plurality of sub-pixel groups in one sub-pixel cluster correspond to a plurality of rows of drive terminals, the row numbers of drive terminals corresponding to the sub-pixel groups including the sub-pixels of the same color in the different sub-pixel groups are the same, and the sub-pixels in the sub-pixel groups are electrically connected to the corresponding drive terminals. In the structure, in each sub-pixel cluster, the sub-pixels of the same color can be driven through the same row of drive terminals, such that the brightness difference among the light-emitting units in different sub-pixel clusters can be reduced, and thus the problem of poor display effect of the display panel in the related technology is solved, thereby improving the display effect of the display panel.

In addition, the embodiments of the present disclosure provide a display device. The display device includes a housing and any one of the display panels according to the above embodiments, wherein the display panel may be disposed on the housing.

As the display device includes the display panel according to the above embodiments, and thus the display device can have a similar effect. That is, the display device solves the problem of the poor display effect of the display panel in the related technology, thereby improving the display effect of the display device.

The display device may be a variety of devices having a display function, such as a smartphone, a smart wearable device, a laptop-type computer, a desktop computer, a television, a monitor, a vertical advertising machine, and various other devices.

The term “and/or” in the present disclosure is merely a description of an association relationship of the associated objects, indicating that three kinds of relationships may exist. For example, A and/or B, which may be expressed as: the existence of A alone, the existence of both A and B, and the existence of B alone. In addition, the character “/” in the text generally indicates that the associated objects before and after are in an “or” relationship.

The term “at least one of A and B” in the present disclosure is merely a description of an association relationship of an associated object, and indicates that three relationships may exist. For example, at least one of A and B may be indicated as: the existence of A alone, the existence of both A and B, and the existence of B alone. Similarly, “at least one of A, B, and C” means that seven relationships may exist, which can be expressed as follows: the existence of A alone, the existence of B alone, the existence of C alone, the existence of both A and B, the existence of both A and C, the existence of both C and B, and the existence of all A, B, and C. Similarly, “at least one of A, B, C and D” means that fifteen relationships may exist, which can be expressed as follows: the existence of A alone, the existence of B alone, the existence of C alone, the existence of D alone, the existence of both A and B, the existence of both A and C, the existence of both A and D, the existence of both C and B, the existence of both D and B, the existence of both C and D, the existence of A, B and C at the same time, the existence of A, B and D at the same time, the existence of A, C and D at the same time, the existence of B, C and D at the same time, the existence of A, B, C and D at the same time.

It should be noted that in the accompanying drawings, the dimensions of the layers and regions may be exaggerated for the sake of clarity of the illustrations. Moreover, it is understood that when an element or layer is referred to as being “on” another element or layer, it may be directly on the other element, or there may be intermediate layers. Also, it is to be understood that when the element or layer is referred to as being “under” another element or layer, it may be directly under the other element, or more than one intermediate layer or element may exist. It is also understood that when a layer or element is referred to as being “between” two layers or elements, it may be the only layer between the two layers or elements, or more than one intermediate layer or element may also exist. Similar reference marks throughout indicate similar elements.

In the present disclosure, the terms “first,” “second,” “third,” and “fourth” are used for descriptive purposes only, and are not to be understood as indicating or implying relative importance. The term “plurality” refers to two or more, unless expressly limited otherwise.

The foregoing are only optional embodiments of the present disclosure and are not intended to limit the present disclosure, and any modifications, equivalent substitutions, improvements, etc. made within the spirit and principles of the present disclosure shall be included in the scope of protection of the present disclosure.

What is claimed is:

1. A display panel, comprising:
a base substrate:
a drive circuit, disposed on the base substrate and comprising a plurality of drive units, wherein the plurality of drive units comprise n rows of drive terminals, n being greater than or equal to two:
a plurality of sub-pixel clusters, disposed on the base substrate, wherein each of the sub-pixel clusters comprises n rows of sub-pixels emitting light of m colors, the n rows of sub-pixels forming n sub-pixel groups, each of the n sub-pixel groups comprising at least one sub-pixel of at least one color, and adjacent sub-pixel groups comprising sub-pixels of different colors, wherein the n sub-pixel groups are in correspondence with the n rows of drive terminals respectively and row numbers of the drive terminals corresponding to the sub-pixel groups comprising the sub-pixels of a same color in different sub-pixel clusters are the same, the sub-pixels in the sub-pixel groups of a K^{th} row are electrically connected to the drive terminals of the K^{th} row, 1≤K≤n.

2. The display panel according to claim 1, wherein n is 2, and the row numbers of the drive terminals corresponding to the sub-pixel groups comprising the sub-pixels of the same color in different sub-pixel clusters have a same parity.

3. The display panel according to claim 1, wherein each of the sub-pixels comprises a light-emitting unit and a sub-pixel circuit, wherein the sub-pixel circuit is electrically connected to the light-emitting unit, and the sub-pixel circuit is further electrically connected to a drive terminal corresponding to the sub-pixel where the sub-pixel circuit is disposed.

4. The display panel according to claim 3, wherein sub-pixel circuits of the n rows of sub-pixels are arranged in n rows on the base substrate, wherein the n rows of sub-pixel circuits correspond to the n rows of drive terminals respectively, and each of the n rows of sub-pixel circuits is electrically connected to a corresponding drive terminal.

5. The display panel according to claim 4, wherein light-emitting units of the n rows of sub-pixels are arranged in n rows on the base substrate, wherein among the n rows of light-emitting units, an orthographic projection of each of the light-emitting units of an x^{th} row on the base substrate is overlapped with an orthographic projection of each of the sub-pixel circuits of an x^{th} row on the base substrate, 1≤x≤n;
a first sub-pixel group of the n sub-pixel groups comprises a target sub-pixel, the light-emitting unit of the target sub-pixel is disposed in the x^{th} row, and the sub-pixel circuit of the target sub-pixel is disposed in an (x+a)^{th} row, 1≤x+a≤n, and a≠0.

6. The display panel according to claim 5, further comprising: a plurality of connection structures, wherein the plurality of connection structures are disposed on the base substrate, a first connection structure of the plurality of connection structures is electrically connected to the light-emitting unit of the target sub-pixel disposed in the x^{th} row, and connected to the sub-pixel circuit of the target sub-pixel disposed in the (x+a)^{th} row, respectively.

7. The display panel according to claim 6, wherein the light-emitting unit comprises a first electrode, an electroluminescent layer, and a second electrode stacked sequentially along a direction away from the base substrate, wherein the first electrode is electrically connected to the first connection structure.

8. The display panel according to claim 7, wherein the first connection structure and the first electrode are disposed in a same layer.

9. The display panel according to claim 8, wherein the sub-pixel circuit comprises a source-drain conductive structure, wherein the source-drain conductive structure comprises a source-drain connection terminal, wherein a second end of the first connection structure is connected to the source-drain connection terminal.

10. The display panel according to claim 7, wherein the sub-pixel circuit comprises a source-drain conductive structure, wherein the first connection structure and the source-drain conductive structure are disposed in a same layer.

11. The display panel according to claim 10, wherein the source-drain conductive structure comprises a first source-drain conductive structure and a second source-drain conductive structure; wherein
the first source-drain conductive structure and the second source-drain conductive structure are arranged in a direction away from the base substrate; and
one end of the first connection structure is connected to the second source-drain conductive structure and the other end of the first connection structure is electrically connected to the first electrode.

12. The display panel according to claim 7, wherein the sub-pixel circuit comprises a source-drain conductive structure and an insulating layer stacked sequentially in a direction away from the base substrate, wherein the source-drain conductive structure is disposed between the light-emitting unit and the base substrate, and the insulating layer is disposed between the source-drain conductive structure and the light-emitting unit;
wherein the first connection structure comprises an adapter wire, and a first via is disposed in the insulating layer, wherein one end of the adapter wire is connected to the source-drain conductive structure through the first via in the insulating layer, and another end of the adapter wire is connected to the light-emitting unit.

13. The display panel according to claim 4, wherein
m is 3, and the sub-pixels of three colors comprise red sub-pixels, blue sub-pixels, and green sub-pixels; and
the sub-pixels in one row comprise a plurality of pixels, wherein each of the plurality of pixels comprises two green sub-pixels, one red sub-pixel, and one blue sub-pixel.

14. The display panel according to claim 13, wherein n is 2, a first sub-pixel group among the two sub-pixel groups comprises the red sub-pixels and the blue sub-pixels, and a second sub-pixel group among the two sub-pixel groups comprises the green sub-pixels, the red sub-pixels and the blue sub-pixels are electrically connected to a first drive terminal among the two rows of the drive terminals, and the green sub-pixels are electrically connected to a second drive terminal among the two rows of the drive terminals.

15. The display panel according to claim 13, wherein each of the sub-pixels comprises the light-emitting unit and the sub-pixel circuit electrically connected to the light-emitting unit:
the display panel further comprises a source-drain data signal line, wherein an orthographic projection of the source-drain data signal line on the base substrate is overlapped with an orthographic projection of at least one of a light-emitting unit of the red sub-pixel and a light-emitting unit of the blue sub-pixel on the base substrate.

16. The display panel according to claim 15, further comprising a thin film transistor and a power line, the power line comprising a shielding block: wherein
the thin film transistor is disposed on the base substrate, the power line is disposed on a side of the thin film transistor away from the base substrate, and an orthographic projection of the shielding block on the base substrate is overlapped with an orthographic projection of the thin film transistor on the base substrate; and
an orthographic projection of a light-emitting unit of the green sub-pixel on the base substrate is overlapped with the orthographic projection of the shielding block on the base substrate.

17. The display panel according to claim 13, wherein n is 3, a first sub-pixel group of the three sub-pixel groups comprises the red sub-pixels, a second sub-pixel group of the three sub-pixel groups comprises the green sub-pixels, and the second sub-pixel group of the three sub-pixel groups comprises the blue sub-pixels:
wherein the red sub-pixels are connected to a first drive terminal of the three drive terminals, the green sub-pixels are connected to a second drive terminal of the three drive terminals, and the blue sub-pixels are connected to a third drive terminal of the three drive terminals.

18. The display panel according to claim 1, wherein
the sub-pixels on the base substrate form pixels of an RGBG structure; or
the sub-pixels on the base substrate form pixels of a GGRB structure.

19. The display panel according to claim 2, wherein sub-pixel circuits and light-emitting units of the n rows of sub-pixels are arranged in n rows respectively on the base substrate, the sub-pixel circuits of the n rows are electrically connected to the light-emitting units of the n rows respectively and the sub-pixel circuits are electrically connected to the drive terminals corresponding to the sub-pixel groups where the sub-pixel circuits are disposed.

20. A display device, comprising: a housing and a display panel, wherein the display panel is disposed on the housing; and
the display panel comprises:
a base substrate;
a drive circuit, disposed on the base substrate and comprising a plurality of drive units, wherein the plurality of drive units comprise n rows of drive terminals, n being greater than or equal to two;
a plurality of sub-pixel clusters, disposed on the base substrate, wherein each of the sub-pixel clusters comprises n rows of sub-pixels emitting light of m colors, the n rows of sub-pixels forming n sub-pixel groups, each of the n sub-pixel groups comprising at least one sub-pixel of at least one color, and adjacent sub-pixel groups comprising sub-pixels of different colors, wherein the n sub-pixel groups are in correspondence with the n rows of drive terminals respectively and row numbers of the drive terminals corresponding to the sub-pixel groups comprising the sub-pixels of a same color in different sub-pixel clusters are the same, the sub-pixels in the sub-pixel groups of a K^{th} row are electrically connected to the drive terminals of the K^{th} row, 1≤K≤n.
